(19) United States
(12) Patent Application Publication
(10) Pub. No.: US 2021/0365962 A1
(43) Pub. Date: Nov. 25, 2021

(54) SYSTEMS AND METHODS OF SELECTING VISUAL ELEMENTS BASED ON SENTIMENT ANALYSIS

(71) Applicant: GOOGLE LLC, Mountain View, CA (US)

(72) Inventors: James TOLENTINO, Mountain View, CA (US); Ira BLOSSOM, Mountain View, CA (US); Zhenshuo FANG, Mountain View, CA (US); Mahalia MILLER, Mountain View, CA (US); Xiaoyu QU, Mountain View, CA (US); Derek DUNFIELD, Mountain View, CA (US); Yeo Jin REE, Mountain View, CA (US); Nihan Gormez KARAHAN, Mountain View, CA (US); Zachary GLEICHER, Mountain View, CA (US); Jeffrey MIELKE, Mountain View, CA (US); Holl LIOU, Mountain View, CA (US); Karin HENNESSY, Mountain View, CA (US)

(73) Assignee: Google LLC, Mountain View, CA (US)

(21) Appl. No.: 16/975,483

(22) PCT Filed: Nov. 13, 2018
(86) PCT No.: PCT/US2018/060806

§ 371 Date: Aug. 25, 2020

(51) Int. Cl. G06Q 30/02; G06N 20/00

(52) U.S. Cl. CPC G06Q 30/0201; G06N 20/00; G06Q 30/0246; G06Q 30/0202; G06Q 30/0245; G06Q 30/0244

(57) ABSTRACT

Systems and methods for selecting visual elements to insert into content items based on sentiment analysis are detailed herein. A data processing system can establish a performance prediction model for content items correlating constituent visual elements to sentiment performance metrics using a training dataset. The data processing system can identify a content item and candidate visual elements to insert. The content item can have constituent visual elements. The data processing system can determine a total sentiment performance metric for the content item using the performance prediction model. The data processing system can determine a combinative performance metric between the candidate visual element and the visual elements using the performance prediction model. The combinative performance metric can indicate a predicted effect on the total performance metric. The data processing system can select a candidate visual element to insert into the content item based on the combinative performance metric.

### BACKGROUND

In a computer networked environment, such as the Internet, content items may be rendered by an application (e.g., web browser) on information resources (e.g., webpages). Each content item of the information resource may be transmitted via the computer networked environment from a different server to a computing device. One or more these different servers may be unauthorized to include content items on information resources.

### SUMMARY

At least one aspect is directed to a method of selecting visual elements to insert into content items based on sentiment analysis. A data processing system having one or more processors can establish a performance prediction model for content items correlating constituent visual elements to sentiment performance metrics using a training dataset having a plurality of test content items. Each test content item can have a plurality of visual elements and a measured sentiment performance metric. The data processing system can identify a content item and a plurality of candidate visual elements to insert into the content item. The content item can have a plurality of constituent visual elements. The data processing system can determine a total sentiment performance metric for the content item using the performance prediction model and the plurality of constituent visual elements of the content item. The data processing system can determine, for each candidate visual element of the plurality of candidate visual elements, a combinative performance metric between the candidate visual element and the plurality of visual elements of the content item using the performance prediction model. The combinative performance metric can indicate a predicted effect on the total performance metric of the content item. The data processing system can select, from the plurality of candidate visual element, a candidate visual element to insert into the content item based on the combinative performance metric for the candidate visual element with the plurality of constituent visual elements in the content item.

In some implementations, the data processing system can present across a plurality of information resources, the content item with the candidate visual element to a first set of client devices and the content item without the candidate visual element on the second set of client devices. In some implementations, the data processing system can determine, from presenting across the plurality of information resources, a first interaction statistic for the content item with the candidate visual element and a second interaction statistic for the content item without the candidate visual element.

In some implementations, the data processing system can present, on each information resource of a plurality of information resources, the content item with the candidate visual element on the information resource. In some implementations, the data processing system can determine, from presenting the content item on the plurality of information resources, an interaction statistic for the content item with the candidate visual element inserted. In some implementations, the data processing system can update the performance prediction model based on the performance metric, the plurality of constituent visual elements of the content item, and the candidate visual element inserted into the content item.

In some implementations, the data processing system can determine, for each constituent visual element of the plurality of constituent visual elements on the content item, a contributive performance metric of the constituent visual element using the performance prediction model. In some implementations, determining the total sentiment performance metric can include determining the total sentiment performance metric based on the plurality of contributive performance metrics for the plurality of constituent visual elements on the content item.

In some implementations, the data processing system can identify a plurality of audience segments to perceive the content item, each audience segment defined by a common trait. In some implementations, establishing the performance prediction model can include establishing the performance prediction model using the training dataset having the plurality of test content items. Each test content item can have the measured sentiment performance metric for each audience segment. In some implementations, determining the total sentiment performance metric can include determining the total sentiment performance metric of the content item for each audience segment of the plurality of audience segments. In some implementations, determining the combinative performance metric can include determining the combinative performance metric of the candidate visual element for each audience segment of the plurality of audience segments.

In some implementations, establishing the performance prediction model can include establishing the performance prediction model using the training dataset. The training dataset can include a first test content item and a second test content item. The first content item can have a visual element at a first location with a first measured sentiment performance metric. The second content item can have the visual element at a second location with a second measured sentiment performance metric. In some implementations, determining the combinative performance metric can include determining the combinative performance metric for the candidate visual element at a candidate location for insertion within the content item using the performance prediction model.

In some implementations, establishing the performance prediction model can include establishing the performance prediction model using the training dataset. Each test content item of the training dataset can have the plurality of visual elements. Each visual element can be having one or more graphical characteristics. In some implementations, determining the combinative performance metric can include the determining the combinative performance metric for the candidate visual element at a candidate location for insertion within the content item using the performance prediction model.

In some implementations, identifying the plurality of constituent visual elements can include identifying the plurality of constituent visual elements by at least one of: applying an object recognition algorithm on rendering of the content item to identify each visual element and parsing a script corresponding to the content item to identify each visual element. In some implementations, the data processing system can receive the measured sentiment performance metric for the test content item having the plurality of visual elements via a survey interface. The measured sentiment performance metric can include at least one of persuasion, linkage, salience, and memorability. In some implementations, the data processing system can present the plurality of candidate visual elements on a content selection management interface based on the plurality of combinative performance metrics for the corresponding plurality of candidate visual elements.

At least one aspect is directed to a system for selecting visual elements to insert into content items based on sentiment analysis. The system can include a model trainer executable on a data processing system having one or more processors. The model trainer can establish a performance prediction model for content items correlating constituent visual elements to sentiment performance metrics using a training dataset having a plurality of test content items. Each test content item can have a plurality of visual elements and a measured sentiment performance metric. The system can include a content interface executable on the data processing system. The content interface can identify a content item and a plurality of candidate visual elements to insert into the content item, the content item having a plurality of constituent visual elements. The system can include a performance estimator executable on the data processing system. The performance estimator can determine a total sentiment performance metric for the content item using the performance prediction model and the plurality of constituent visual elements of the content item. The performance estimator can determine, for each candidate visual element of the plurality of candidate visual elements, a combinative performance metric between the candidate visual element and the plurality of visual elements of the content item using the performance prediction model. The combinative performance metric can indicate a predicted effect on the total performance metric of the content item. The system can include an element selector executable on the data processing system. The element selector can select, from the plurality of candidate visual element, a candidate visual element to insert into the content item based on the combinative performance metric for the candidate visual element with the plurality of constituent visual elements in the content item.

In some implementations, the system can include a presentation tracker executable on the data processing system. The presentation tracker can present across a plurality of information resources, the content item with the candidate visual element to a first set of client devices and the content item without the candidate visual element on the second set of client devices. In some implementations, the presentation tracker can determine, from presenting across the plurality of information resources, a first interaction statistic for the content item with the candidate visual element and a second interaction statistic for the content item without the candidate visual element.

In some implementations, the system can include a presentation tracker executable on the data processing system. The presentation tracker can present, on each information resource of a plurality of information resources, the content item with the candidate visual element on the information resource. In some implementations, the presentation tracker can determine, from presenting the content item on the plurality of information resources, an interaction statistic for the content item with the candidate visual element inserted. In some implementations, the model trainer can update the performance prediction model based on the performance metric, the plurality of constituent visual elements of the content item, and the candidate visual element inserted into the content item.

In some implementations, the performance estimator can determine, for each constituent visual element of the plurality of constituent visual elements on the content item, a contributive performance metric of the constituent visual element using the performance prediction model. In some implementations, the performance estimator can determine the total sentiment performance metric based on the plurality of contributive performance metrics for the plurality of constituent visual elements on the content item.

In some implementations, the model trainer can identify a plurality of audience segments to perceive the content item, each audience segment defined by a common trait. In some implementations, the model trainer can establish the performance prediction model using the training dataset having the plurality of test content items. Each test content item can have the measured sentiment performance metric for each audience segment. In some implementations, the performance estimator can determine the total sentiment performance metric of the content item for each audience segment of the plurality of audience segments. In some implementations, the performance estimator can determine the combinative performance metric of the candidate visual element for each audience segment of the plurality of audience segments.

In some implementations, the model trainer can establish the performance prediction model using the training dataset. The training dataset can include a first test content item and a second test content item. The first content item can have a visual element at a first location with a first measured sentiment performance metric. The second content item can have the visual element at a second location with a second measured sentiment performance metric. In some implementations, the performance estimator can determine the combinative performance metric for the candidate visual element at a candidate location for insertion within the content item using the performance prediction model.

In some implementations, the model trainer can establish the performance prediction model using the training dataset. Each test content item of the training dataset can have the plurality of visual elements. Each visual element can be having one or more graphical characteristics. In some implementations, the performance estimator can determine, for a candidate time duration of a plurality of candidate time durations. The combinative performance metric can be between the candidate visual elements displayed for the time duration using the performance prediction model.

In some implementations, the content interface can identify the plurality of constituent visual elements by at least one of: applying an object recognition algorithm on rendering of the content item to identify each visual element and parsing a script corresponding to the content item to identify each visual element. In some implementations, the model trainer can receive the measured sentiment performance metric for the test content item having the plurality of visual elements via a survey interface. The measured sentiment performance metric can include at least one of persuasion, linkage, salience, and memorability. In some implementations, the element selector can present the plurality of candidate visual elements on a content selection management interface based on the plurality of combinative performance metrics for the corresponding plurality of candidate visual elements.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one implementation of an environment for selecting visual elements based on sentiment analysis in a computer network environment, according to an illustrative implementation;

FIGS. 2A-2C each is a block diagram depicting a graphical user interface (GUI) for selecting visual elements based on sentiment analysis;

FIGS. 3A-3C each is a screenshot of a graphical user interface (GUI) for selecting visual elements based on sentiment analysis;

FIG. 4 is a flow diagram depicting a method of selecting visual elements based on sentiment analysis, according to an illustrative implementation; and

FIG. 5 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of selecting visual elements based on sentiment analysis in a computer network environment. The various concepts introduced above and discussed in greater detail below may be implemented in any of numerous ways, as the described concepts are not limited to any particular manner of implementation.

Content placement platforms can present interaction performance data of individual content items. Examples of such interaction performance data can include click-through rates, hover rates, and a number of views. The content placement platforms, however, may lack any display or calculation of any insight or contributory factors in the interaction performance data. In addition, these platforms may not provide or factor in any performance data regarding the sentiment or psychological responses on part of users on the content items. The capability of determining and providing sentiment responses of users to the content items may be useful in selection of content items for insertion onto information resources (e.g., webpages). The lack of these functionalities may lead to wasted networking and computing resources, with content items placed and displayed onto information resources without any interaction or response on the part of the viewer.

To address the lack of these capabilities, the content placement platform can use a prediction model to determine a correlation between constituent visual elements of a content item and a performance data of the content item as a whole. The performance data can include interaction performance metrics (e.g., click-through rates, hover rates, and number of views) as well as sentiment performance metrics (e.g., persuasion, linkage, salience, and memorability). The prediction model can be in accordance with any number of machine learning techniques, such as artificial neural networks, support-vector machines, Bayesian networks, and Markov models, among others. To train the prediction model, a training dataset including correlations of visual elements on content items with measured performance metrics can be used. The interaction performance metrics of the training dataset can be determined from measuring interaction statistics from presentations across multiple information resources. The sentiment performance metric of the training dataset can be aggregated from a survey inquiring viewers of content items their psychological responses to the content item.

The platform can apply the prediction model to the constituent visual elements of a content item to determine a predicted performance metric. The constituent visual elements of the content item can be extracted and identified using image recognition techniques or parsing of the script for the content item. The predicted performance metric can include the interaction performance metric as well as the sentiment performance metric for the content item. The platform can also calculate a contributive measure of each visual element to the overall predicted performance metric for the content item. Using the prediction model, the platform can also select one or more candidate visual elements to add or insert onto the content item. The platform can apply the prediction model to various permutations of the constituent visual element along with the candidate visual elements to calculate the predicted performance metric of the content item. Using the predicted performance metrics for the candidate visual elements, the platform can select one or more of the candidate visual elements as recommendations to insert into the content item.

Once selected and placed into the content placement campaign, the platform can track and measure the performance data of the content item. In tracking and measuring the performance data, the platform can run AB testing of the content item with various visual elements inserted therein. Using the results of the testing, the platform can continuously update the prediction model to provided updated recommendations to insert into the content item.

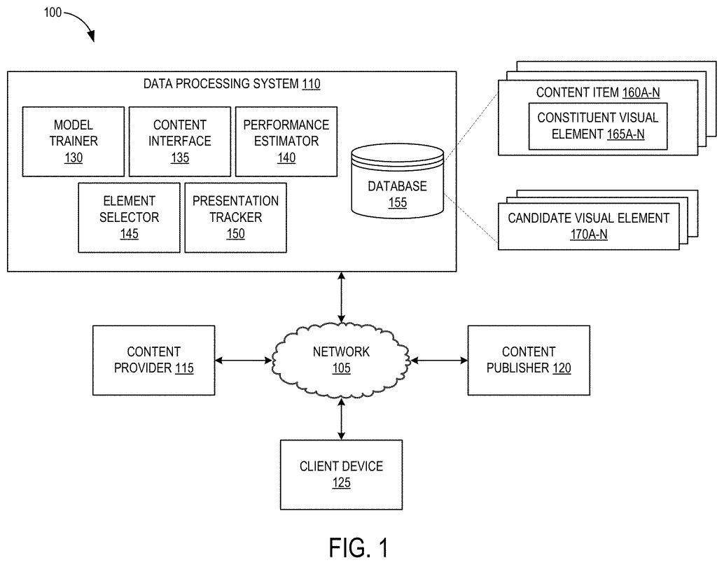

FIG. 1 is a block diagram depicting one implementation of an environment for deploying countermeasures against unauthorized scripts interfering with the rendering of content elements on information resources in a computer network environment. The environment 100 includes at least one data processing system 110. The data processing system 110 can include at least one processor and a memory, i.e., a processing circuit. The memory stores processor-executable instructions that, when executed by processor, cause the processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language. The data processing system can include one or more computing devices or servers that can perform various functions. In some implementations, the data processing system can include an advertising auction system configured to host auctions. In some implementations, the data processing system does not include the advertising auction system but is configured to communicate with the advertising auction system via the network 105.

The network 105 can include computer networks such as the internet, local, wide, metro or other area networks, intranets, satellite networks, other computer networks such as voice or data mobile phone communication networks, and combinations thereof. The data processing system 110 of the system 100 can communicate via the network 105, for instance with at least one content provider 115, at least one content publisher 120, or at least one client device 125. The network 105 may be any form of computer network that relays information between the client device 125, data processing system 110, and one or more content sources, for example, web servers, advertising servers, amongst others. For example, the network 105 may include the Internet and/or other types of data networks, such as a local area network (LAN), a wide area network (WAN), a cellular network, satellite network, or other types of data networks. The network 105 may also include any number of computing devices (e.g., computer, servers, routers, network switches, etc.) that are configured to receive and/or transmit data within network 105. The network 105 may further include any number of hardwired and/or wireless connections. For example, the client device 125 may communicate wirelessly (e.g., via WiFi, cellular, radio, etc.) with a transceiver that is hardwired (e.g., via a fiber optic cable, a CAT5 cable, etc.) to other computing devices in network 105.

The content providers 115 can include servers or other computing devices operated by a content provider entity to provide content elements to the content publishers 120 or the data processing system 110. The content provided by the content provider 115 can include third party content elements for display on information resources, such as a website or web page that includes primary content, e.g. content provided by the content publisher 120. The content elements can also be displayed on a search results web page. The content elements associated with the content provider 115 can be displayed on information resources other than web pages, such as content displayed as part of the execution of an application on a smartphone or other client device 125. The content publishers 120 or the data processing system 110 in turn can select the content elements of the content providers 115. For example, the data processing system 110 can run an ad auction to select the content elements based on various performance metrics of the respective content elements. The content publishers 120 or the data processing system can transmit the selected content elements of the content provider computing devices for display on information resources at the client devices 125.

The content publishers 120 can include servers or other computing devices operated by a content publishing entity to provide primary content for display via the network 105. For instance, the content publisher 120 can include a web page operator who provides primary content for display on the web page. The content publishers 120 can also provide third party content received from the content providers 115 for display via the network 105. The primary content can include content other than that provided by the content publisher 120, and the web page can include content slots configured for the display of content elements received by the content publishers 120 from the content providers 115. For instance, the content publisher 120 can operate the website of a company and can provide content about that company for display on web pages of the website. The web pages can include content slots configured for the display of content elements such as images, text, videos, or any combination thereof received from the content provider 115. In some implementations, the content publisher 120 includes a search engine computing device (e.g. server) of a search engine operator that operates a search engine website. The primary content of search engine web pages (e.g., a results or landing web page) can include results of a search as well as third party content elements displayed in content slots such as content elements from the content provider 115. In some implementations, the content publisher 120 can include a server for serving video content.

The client devices 125 can include computing devices configured to communicate via the network 105 or via the network 105 to display data such as the content provided by the content publisher 120 (e.g., primary web page content or other information resources) and the content provided by the content provider 115 (e.g., content elements configured for display in an information resource). The client device 125, the content provider 115, and the content publisher 120 can include desktop computers, laptop computers, tablet computers, smartphones, personal digital assistants, mobile devices, consumer computing devices, servers, clients, digital video recorders, a set-top box for a television, a video game console, or any other computing device configured to communicate via the network 105. The client device 125 can be communication devices through which an end user can submit requests to receive content. The requests can be requests to a search engine and the requests can include search queries. In some implementations, the requests can include a request to access a web page.

The content providers 115, the content publisher 120, and the client device 125 can include a processor and a memory, i.e., a processing circuit. The memory stores machine instructions that, when executed by processor, cause processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language.

The content providers 115, the content publishers 120, and the client device 125 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of the content providers 115, the content publisher 120 and the client device 125 (e.g., a built-in display, microphone, etc.) or external to the housing of content providers 115, the content publisher 120 and the client device 125 (e.g., a monitor connected to the client device 125 and a speaker connected to the client device 125, etc.), according to various implementations. For example, the content providers 115, the content publisher 120 and the client device 125 may include an electronic display, which visually displays web pages using webpage data received from one or more content sources and/or from the data processing system 110 via the network 105.

The data processing system 110 can include at least one server. For instance, the data processing system 110 can include a plurality of servers located in at least one data center or server farm. In some implementations, the data processing system 110 includes a content placement system, e.g., an ad server or ad placement system. The data processing system 110 can include at least one model trainer 130, at least one content interface 135, at least one performance estimator 140, at least one element selector 145, at least one presentation tracker 150, and at least one database 155. The model trainer 130, the content interface 135, the performance estimator 140, the element selector 145, and the presentation tracker 150 each can include at least one processing unit, server, virtual server, circuit, engine, agent, appliance, or other logic device such as programmable logic arrays configured to communicate with the database 155 and with other computing devices (e.g., the content provider 115, the content publisher 120, or the client device 125) via the network 105. The model trainer 130, the content interface 135, the performance estimator 140, the element selector 145, the presentation tracker 150, and the database 155 can include or execute at least one computer program or at least one script. The model trainer 130, the content interface 135, the performance estimator 140, the element selector 145, the presentation tracker 150 can be separate components, a single component, or part of the data processing system 110. The model trainer 130, the content interface 135, the performance estimator 140, the element selector 145, the presentation tracker 150 can include combinations of software and hardware, such as one or more processors configured to execute one or more scripts.

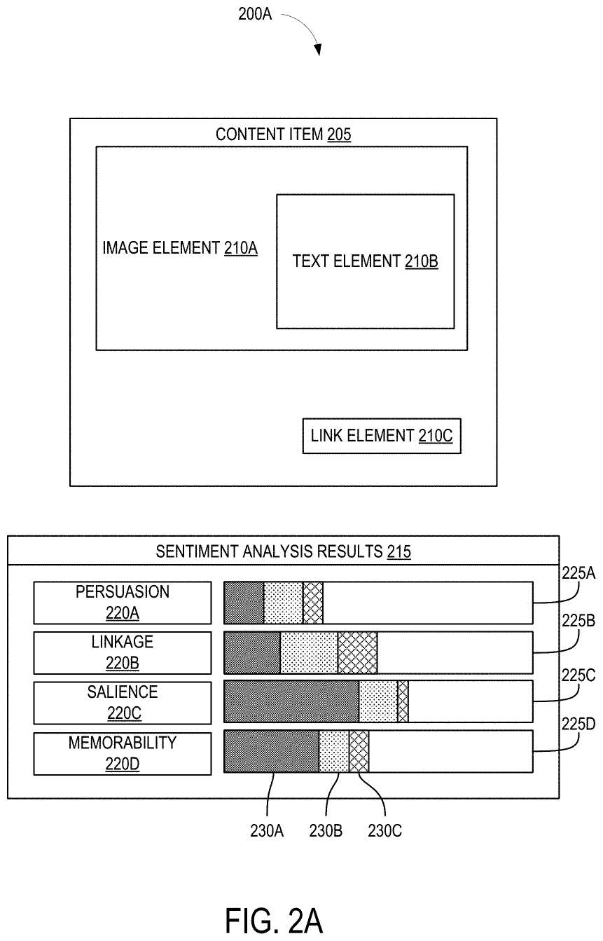

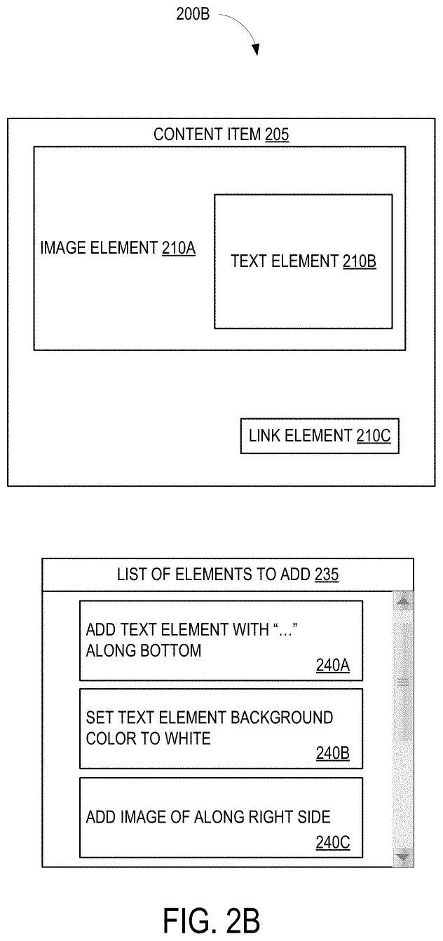

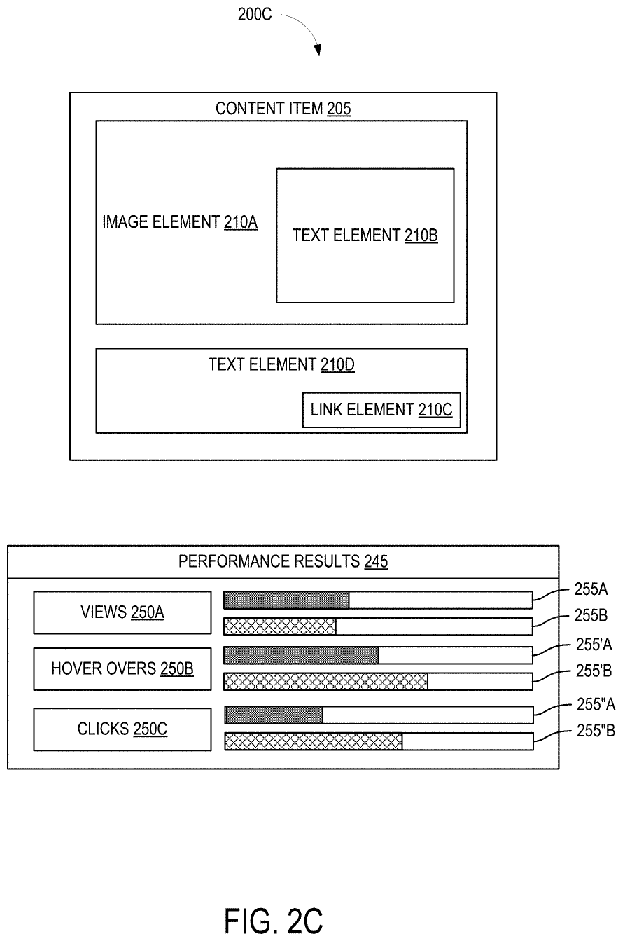

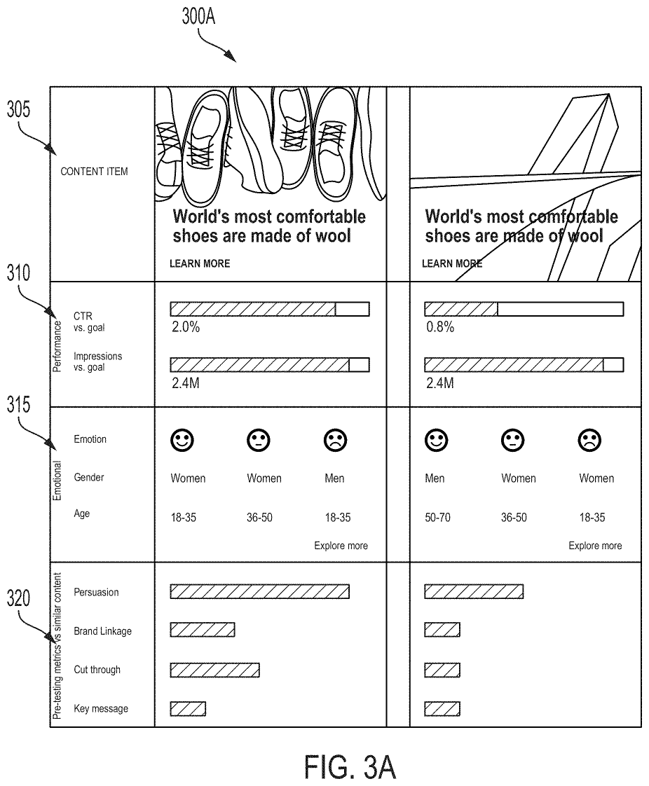

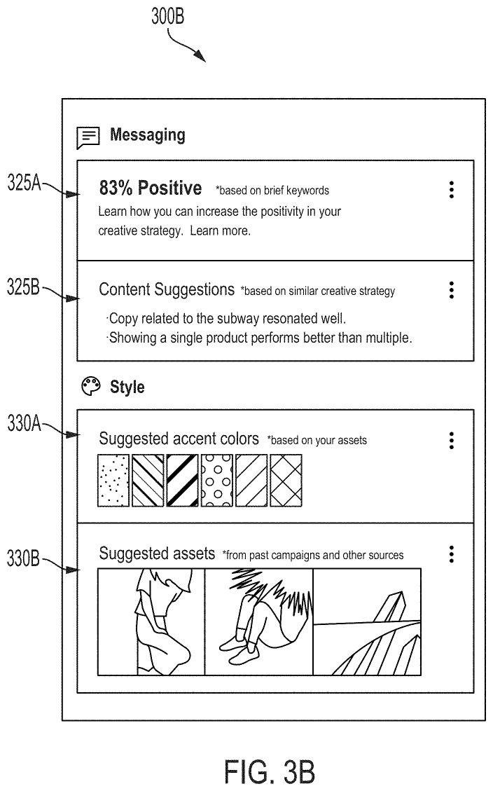

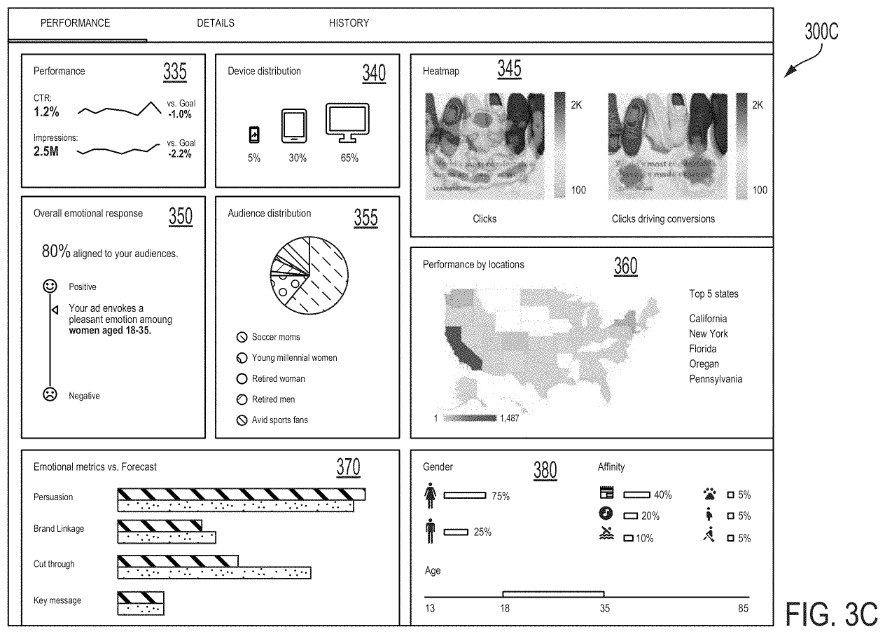

The data processing system 110 can also include one or more content repositories or databases 155. The databases 155 can be local to the data processing system 110. In some implementations, the databases 155 can be remote to the data processing system 110 but can communicate with the data processing system 110 via the network 105. The databases 155 can include information resources (e.g., webpages), content items, and a model to select content items among others, to serve to a client device 125. In some implementations, information resources and content elements of the information resources can include those illustratively depicted in FIGS. 2A-2C. The databases 155 can include interfaces for content selection campaigns to administer distribution and selection of content items to provide to the client devices 125 via the network 105. In some implementations, the interfaces can include those illustrative depicted in FIGS. 2A-3C. Additional details of the contents of the database 155 will be provided below.

The model trainer 130 can establish a performance prediction model for content items to correlate constituent visual elements to sentiment performance metrics or to interaction performance metrics. The performance prediction model can be used to predict the sentiment performance metrics or the interaction performance metrics of a content item based on the constituent visual elements included in the content item. Each content item can include one or more constituent visual elements. Each content item can include or correspond to one or more Document Object Model (DOM) element, such as an image element, a text element, a link element, a video element, and a canvas element, among others, or any combination thereof. For each content item, the constituent visual elements can include or correspond to one or more of the DOM elements of the content item. The constituent visual elements can have one or more graphical characteristics, such as a position within the content item, a size, a color (or constituent colors identified by pixel-by-pixel), and a font style among others. In some implementations, the constituent visual elements can include or correspond to at least a portion of one DOM element of the content item. For example, one constituent visual element can correspond to a left subset portion of an image element, while another constituent visual element can correspond to a right subset portion of the same image element of the content item.

The content items can be correlated or otherwise associated with sentiment performance metrics or interaction performance metrics. The sentiment performance metrics can measure or can correspond to psychological perceptions or responses on the part of an end user when presented with the content item through the client device 125. The sentiment performance metrics can include various types of perceptions or responses, and can include persuasion, linkage, salience, memorability, and emotion, among others. Persuasion can correspond to a likelihood that the end user will change an attitude or behavior in response to presentation of the content item. Linkage can correspond to a likelihood that the end user will associate or connect a message the content item to an entity associated with the content item when presented with the content item. Salience can correspond to a likelihood that the end user will notice the content item when presented on the information resource. Memorability can correspond to a likelihood that the end user will recall a message or entity of the content item for a time duration (e.g., 12 hours to a week after seeing the content item) subsequent to presentation of the content item. Emotion can correspond to a likelihood that the end user will respond with a particular feeling (e.g., happiness, surprise, neutral, sadness, anger, disgust, and fear) when presented with the content item. In each type of perception or psychological response, the likelihood can be a numerical value (e.g., between −1 to 1, 0 to 1, −10 to 10, 0 to 10, −100 to 100, or 0 to 100). In addition, the interaction performance metrics can measure or can correspond to interactions using input/output (I/O) devices of the client device 125 by the end user with the content item, when presented through the client device 125. The interaction performance metrics can include various types of interactions, such as a number of views, a rate of hover-overs, and a rate of clicks, among others with the content item using the I/O devices of the client device 125.

In establishing the performance prediction model, the model trainer 130 can use a training dataset to train the performance prediction model. The performance prediction model can be, for example, an artificial neural network (ANN), a convolution neural network (CNN), a support vector machine (SVM), a Naïve Bayes classifier, a Bayesian model, a Markov model, and a regression model (linear or logistic), among others, and can be trained according to the type of model. The performance prediction model can have a set of inputs, a set of outputs, and a set of weights specifying a relationship between the inputs and the outputs of the performance prediction model. The set of inputs in the performance prediction model can include the graphical characteristics of the constituent visual elements of the content item. The set of outputs of the performance prediction model can include the various types of psychological responses for the sentiment performance metrics and the types of the interaction performance metrics. The set of weights can correlate the graphical characteristics of the content item to numeric values for the sentiment performance metrics and the interaction performance metrics. In some implementations, the model trainer 130 can train separate performance prediction models for different types of sentiment performance metrics and interaction performance metrics.

The model trainer 130 can retrieve or identify the training dataset to train the performance prediction model from the database 155. The training dataset can include a set of test content items associated with measured sentiment performance metrics or measured interaction performance metrics, among others. The training dataset can specify graphical characteristic of each content item, such as size, color, and font style, among others. In some implementations, the training dataset can specify the graphical characteristics of each constituent visual elements of the test content items. The graphical characteristics of the constituent visual elements of the test content items can include position, size, color, and font style, among others. In some implementations, the graphical characteristic of at least one of the constituent visual element of the test content item can include a time duration. For example, the constituent element can change or disappear during a time duration while presented on the test content item. The measured sentiment performance metrics or the measured interaction performance metrics can be associated with the time durations of the constituent visual elements changing or disappearing from the content item. In some implementations, the training dataset can include multiple test content items with at least one same constituent visual element in different locations within the test content item. The measured sentiment performance metrics or the measured interaction performance metrics for the test content item differ with the same constituent visual elements at different locations within the test content item.

In some implementations, the sentiment performance metrics of the training dataset can be from a panel study data with a set of end user presented with the test content item. The panel study data can include a survey from the set of end users, indicating the persuasion, the linkage, the salience, the memorability, and the emotion of the content item by the end user. The survey can include, for example, questions regarding the content item to which the end user is to answer. In some implementations, the panel study data can indicate audience segments to which the end user of the panel study belongs to. Each audience segment can be defined by a common trait (e.g., geographic location or device type). In some implementations, the interaction performance metrics of the training dataset can be from a previous distribution by the data processing system 110 (or some other servers) and presentation of the test content items to the client devices 125 via the network 105. From the previous distribution and presentation, the number of views, a rate of hover-overs, and a rate of click through can be determined.

In some implementations, the training dataset can specify an external characteristic for each test content item or for each visual constituent visual element. The external characteristic can include a topical category of an information resource (e.g., a webpage) on which the test content item is inserted. The topical category can correspond to, for example, a semantic synopsis of textual content on the information resource or an entity associated with the information resource. The external characteristic can include a designated audience segment. The designated audience segment can be defined by a common trait, such as geographic location, device type, and population type, among others. The external characteristic can be independent of the interaction performance metrics or the sentiment performance metric.

The model trainer 130 can apply the training dataset onto the performance prediction model to train the performance prediction model. The model trainer 130 can feed the training data into the performance prediction model until the performance prediction model reaches convergence. In feeding the training data, the model trainer 130 can adjust or modify the set of weights in the performance prediction model to correlate various constituent visual elements of content items to the sentiment performance metric and the interaction performance metric for the content item. Once trained, the performance prediction model can be used by the data processing system 110 to predict the sentiment performance metric and the interaction performance metric of other content items using the constituent visual elements. Furthermore, the performance prediction model can be used by the data processing system 110 to determine the effects of the various constituent visual elements to the overall sentiment performance metric and the interaction performance metric of the content item. The performance prediction model can be also used by the data processing system 110 to correlate the visual elements, the sentiment performance metrics, and the interaction performance metrics for the content item. In addition, the performance prediction model can be used by the data processing system 110 to determine the sentiment performance metric and the interaction performance metric for different audience segments.

With the training of the performance prediction model, the content interface 135 can retrieve or identify at least one content item 160A-N (hereinafter generally referred to as content item 160) to which to insert or add one or more visual element from a set of candidate visual elements 170A-N (hereinafter generally referred to as candidate visual element 170). The retrieval or identify of the content items from the database 155 can be responsive to a request to add visual elements to the content item 160. In some implementations, the request itself can include the content item 160 to which to insert the visual elements from the set of candidate visual elements 170. In some implementations, the request may be made via a content selection management interface. In some implementations, the content interface 135 can access the database 155 to retrieve or identify the content items 160 to which to insert or add visual elements from the set of candidate visual elements 170. In some implementations, the content interface 135 can receive the content items 160 from the content provider 115. The content item itself 160 can already include one or more constituent visual elements 165, such as an image element, a text element, a link element, a video element, and a canvas element, among others. In some implementations, the performance estimator 140 can identify graphical characteristics of the overall content item 160, such size, color (or constituent colors identified by pixel-by-pixel), and font style, among others.

To identify the constituent visual elements 165 of each content item 160, the content interface 135 can apply an object recognition algorithm on the content item 160. The object recognition algorithms can include scale-invariant feature transform (SIFT) algorithm, speeded up robust features (SURF) algorithm, geometric hashing algorithm, optical character recognition, face detection, pose estimation, and other pattern recognition techniques. By applying the object recognition algorithm onto the content item 160, the content interface 135 can also identify the graphical characteristics of each constituent visual element 165, such as the position, size, color, and font style, among others. The content interface 135 can also parse a script corresponding to the content item to identify each constituent visual element 165. The script can be in a markup language (e.g., HyperText Markup Language (HTML) and Cascading Style Sheets (CSS)), and specify how an application (e.g., a web browser) is to render the content item on the information resource (e.g., a webpage). In parsing the script corresponding to the content item, the content interface 135 can identify the one or more DOM elements within the content item 160 as constituent visual elements 165 of the content item. In some implementations, the content interface 135 can identify a subset of DOM elements specified as to be rendered as the constituent visual element 165 of the content item 160. The content interface 135 can also identify the graphical characteristics of each identified constituent visual element 165 of the content item 160.

The content interface 135 can also identify the set of candidate visual elements 170 from which to insert the visual element to the content item. In some implementations, the content interface 135 can access the database 155 to retrieve or to identify the set of candidate visual elements 170. The set of candidate visual elements 170 can include any type of DOM element, such as an image element, a text element, a link element, a video element, and a canvas element, among others. At least one of the candidate visual elements 170 can be inserted or added to the content item 160. Each candidate visual element 170 can include or specify one or more graphical characteristics, such as the position, size, color, font style, and time duration, among others. In some implementations, candidate visual elements 170 with the same size, color, and font style can different in the time duration that the candidate visual element 170 is to be displayed. In some implementations, the content interface 135 can identify a subset of candidate visual elements from the total set based on the constituent visual elements 165 included in the content item 160. For each candidate visual element 165, the content interface 135 can compare a type of the candidate visual element 170 with types of constituent visual elements 165 included in the content item 160. From the comparison, the content interface 135 can identify one or more matches between the type of the candidate visual element 170 and the types of the constituent visual elements 165. Responsive to the identification, the content interface 135 can remove the candidate visual element 170 from the set of candidate visual elements 170 from which to insert or add to the content item 160. For example, the content interface 135 can identify that a link element is already included in the content item 160. The content interface 135 can remove a link element from the set of candidate visual elements 170 to which to add to the content item 160 to avoid redundancy in the same types of elements appearing on the content item 160. On the other hand, the content item interface 135 can identify non-matching types of candidate visual elements 170 in comparison to the types of the constituent visual elements 165. Responsive to the identification, the content interface 135 can maintain or include the candidate visual element 170 to the set of candidate visual elements 170 from which to insert to the content item 160.

In some implementations, the content interface 135 can apply object recognition techniques to identify one or more candidate locations in which to insert the candidate visual element 170 within the content item 160. Each candidate location can identify coordinates of the bounds and the size of the bound. For example, using the object recognition technique, the content interface 135 can identify a rectangular negative space among the constituent visual elements 165 of the content item 160 as a candidate location to which to insert the candidate visual element 170. For each candidate location, the content interface 135 can select or identify a subset of the candidate visual elements 170 as compatible with the candidate location based on the specified visual characteristic of the candidate visual element 170. In some implementations, the content interface 135 can compare the specified size of each candidate visual element 170 with the identified size of the candidate location. When the size of the candidate visual element 170 is determined to be larger than the identified size of the candidate location, the content interface 135 can determine that the candidate visual element 170 is incompatible with the candidate location. The content interface 135 can also remove the candidate visual element 170 from the subset of candidate visual elements 170 to insert to the content item 160. Conversely, when the size of the candidate visual element 170 is determined to be smaller than the identified size of the candidate location, the content interface 135 can determine that the candidate visual element 170 is compatible with the candidate location. The content interface 135 can also include the candidate visual element 170 to the subset of candidate visual elements 170 to add to the content item 160.

With the identification of the content item 160 and the constituent visual elements 165 thereof, the performance estimator 140 can calculate, predict, estimate, or otherwise determine at least one total performance metric for the content item 160 using the performance prediction model. The total performance metric can indicate or correspond to an overall measure of the entire content item 160 with the constituent visual elements 165 in terms of interaction performance or semantic performance. The total performance metric can include a total semantic performance metric or a total interaction semantic metric for the overall content item 160 including all the constituent visual elements 165. The total semantic performance metric for the content item 160 can be of any type, such as persuasion, linkage, salience, memorability, and emotion, among others. The total interaction performance metric for the content item 160 can be of any type, such as the number of views, a rate of hover overs, and a rate of click through, among others. In some implementations, the performance estimator 140 can apply the one or more graphical characteristics of the overall content item 160 as inputs to the performance prediction model. With the application onto the inputs, the performance prediction model can output the contributive performance metric of the individual constituent visual element 165 via the weights of the model. From the outputs of the performance prediction model, the performance estimator 140 can determine the total performance metric of the content item 160.

In determining the total performance metric of the content item 160, the performance estimator 140 can calculate, predict, estimate, or determine a contributive performance metric of each constituent visual element 165. The contributive performance metric can indicate or correspond to a factorial measure of each constituent visual element 165 to the overall, total performance metric of the content item 160. The contributive performance metric can include a contributive semantic performance metric or a contributive interaction semantic metric of the constituent visual element 165 of the content item 160. To determine the contributive performance metric, the performance estimator 140 can apply each constituent visual element 165 as an input to the performance prediction model. Additional parameters can be applied by the performance estimator 140 as inputs to the performance prediction model. In some implementations, the performance estimator 140 can apply the one or more graphical characteristics of the constituent visual element 165 as inputs to the performance prediction model. As detailed above, the graphical characteristics of the constituent visual elements 165 can include position, size, color, font style, and time duration, among others. In some implementations, the performance estimator 140 can apply the one or more graphical characteristics of the overall content item 160 as the inputs to the performance prediction mode in determining the contributive performance metrics of each constituent visual element 165. With the application onto the inputs, the performance prediction model can output the contributive performance metric of the individual constituent visual element 165 via the weights of the model. From the outputs of the performance prediction model, the performance estimator 140 can obtain or determine the contributive performance metric of each constituent visual element 165.

In some implementations, the performance estimator 140 can identify or determine a set of arrangements (e.g., permutations) of the constituent visual elements 165 of the content item 160 to discern the contributive performance metric. Each arrangement can include one or more of the constituent visual elements 165 from the content item 160. The performance estimator 140 can apply the graphical characteristics of each arrangement of the constituent visual elements 165 to the performance prediction model. The performance estimator 140 can iterate through the arrangements of constituent visual elements 165 in applying as inputs to the performance prediction model. From the output of the performance prediction model, the performance estimator 140 can determine a component performance metric for the arrangement of constituent visual elements 165 inputted into the performance prediction model. The component performance metric can include a semantic performance metric or a interaction semantic metric of the arrangement of constituent visual elements 165. Based on the component performance metrics over the entire set of arrangements, the performance estimator 140 can determine the contributive performance metrics of the constituent visual elements 165 of the content item 160. In some implementations, the performance estimator 140 can apply factor analysis techniques to determine the contributive performance metric of each constituent visual element 165. The factor analysis techniques can include, for example, exploratory factor analysis, confirmatory factor analysis, regression analysis, and principal component analysis, among others.

In some implementations, the contributive performance metrics of the constituent visual elements 165 determined by the performance estimator 140 can be for a particular audience segment using the performance prediction model. As discussed above, each audience segment can be defined by a common trait (e.g., geographic location or device type). The contributive sentiment performance metric or the contributive interaction performance metric can differ from one audience segment to another audience segment. For example, a constituent visual element 165 can have a different sentiment performance metric when presented via a smartphone or via a laptop computer. In some implementations, the performance estimator 140 can receive or identify a selection of one or more audience segments for which to determine the sentiment performance metrics and the interaction performance metrics. The selection may be made via a content selection management interface. In some implementations, the audience segment can be identified using a segment classifier identifier (e.g., an alphanumeric string). In some implementations, the performance estimator 140 can apply each audience segment as an input to the performance prediction model to determine the contributive performance metric of each constituent visual element 165. From the outputs of the performance prediction model, the performance estimator 140 can obtain or determine the contributive performance metric of each constituent visual element 165 for each audience segment.

Based on the contributive performance metrics of each constituent visual element 165, the performance estimator 140 can calculate, predict, estimate, or otherwise determine the total performance metric of the overall content item 160. In some implementations, the performance estimator 140 can determine the total performance metric of the content item 160 based on a combination (e.g., a summation) of the contributive performance metrics of the constituent visual elements 165. In some implementations, the total performance metric of the content item 160 overall determined by the performance estimator 140 can be for a particular audience segment using the performance prediction model. The performance estimator 140 can determine the total performance metric of the content item 160 per audience segment based on a combination of the contributive performance metric of the constituent visual elements 165 for the audience segment. The contributive performance metrics of some of the constituent visual element 165 can be positive, leading to an additive effective to the total performance metric of the content item 160. On the other hand, the contributive performance metrics of some of the constituent visual elements 165 can be negative, resulting in a subtractive effect to the total performance metric of the content item 160. In addition, the additive or subtractive effects can differ, based on the type of performance metric determined. For example, one constituent visual element 165 can have a positive contributive performance metric for salience and hover-over rates, but can have a negative contributive performance metric for persuasion and click-through rates. The combination of the contributive performance metrics of each individual constituent visual element 165 can yield the total performance metric of the content item 160.

With the identification of each candidate visual element 170, the performance estimator 140 can calculate, predict, estimate, or otherwise determine a combinative performance metric with the candidate visual element 170 and the constituent visual elements 165 of the content item 160. The combinative performance metric can indicate a factorial effect to the total performance metric of the content item 160, in response to the addition of the candidate visual element 170 to the content item 160. In some implementations, the performance estimator 140 can identify one or more graphical characteristics of the candidate visual element 170, such as size, color, font style, and time duration, among others. For each candidate visual element 170, the performance estimator 140 can apply at least one of the candidate visual elements 170 as an input to the performance prediction model to determine the combinative performance metric. Additional parameters can be applied by the performance estimator 140 as inputs to the performance prediction model. In some implementations, the performance estimator 140 can apply the one or more graphical characteristics of the content item 160 overall as inputs to the performance prediction model. In some implementations, the performance estimator 140 can apply the one or more graphical characteristics of the candidate visual element 170 onto the inputs of the performance prediction model. In some implementations, the performance estimator 140 can apply each candidate location within the content item 160 identified as compatible with the candidate visual element 170 as one of the graphical characteristics onto the input of the performance prediction model. For example, a position corresponding to the candidate location can be included by the performance estimator 140 into the one or more graphical characteristics of the candidate visual element 170 as an input to the performance prediction model. In some implementations, the performance estimator 140 can apply the one or more audience segments as inputs to the performance prediction model in determining the combinative performance metric of the candidate visual element 170.

With the application onto the inputs, the performance prediction model can output the combinative performance metric of the candidate visual element 170 when inserted into the content item 160 via the weights of the model. From the outputs of the performance prediction model, the performance estimator 140 can determine the combinative performance metric of the candidate visual element 170. In some implementations, the combinative performance metric of the candidate visual element 170 determined by the performance estimator 140 can be for a particular audience segment using the performance prediction model. The combinative performance metric of the candidate visual element 170 can be positive, leading to an additive effective to the total performance metric of the content item 160. On the other hand, the combinative performance metrics of the candidate visual element 170 can be negative, resulting in a subtractive effect to the total performance metric of the content item 160. Furthermore, the additive or subtractive effects can differ, based on the type of performance metric (e.g., semantic or interaction).

In some implementations, the performance estimator 140 can determine an aggregate performance metric for the content item 160 when the candidate visual element 170 is inserted into the content item 160. The determination of the aggregate performance metric can be based on a combination (e.g., a summation) the combinative performance metric of the candidate visual elements 170 and the contributive performance metrics of the constituent visual elements 156 included in the content item 160. For determining the aggregate performance metric, the performance estimator 140 can determine the combination of the same type of the performance metric (e.g., semantic or interaction). The aggregate performance metric of the content item 160 with the candidate visual element 170 inserted can differ (e.g., greater or less than) the total performance metric of the content item 160 without the candidate visual element 170. The aggregate performance metric thus can be reflective of the additive or subtractive effect of the combinative performance metric of the candidate visual element 170 when inserted into the content item 160.

In some implementations, the performance estimator 140 can identify or determine a set of arrangements (e.g., permutations) that includes the candidate visual element 170 and at least one of the constituent visual elements 165. Each arrangement can include one or more of the constituent visual elements 165, together with one or more of the candidate visual elements 170 inserted within the content item 160. The performance estimator 140 can iterate through the arrangements of constituent visual elements 165 with the candidate visual element 170 in applying as inputs to the performance prediction model. In some implementations, the arrangement can include one or more of the constituent visual elements 165 and the candidate visual element 170 at different candidate locations. The candidate locations, as discussed above, can be locations within the content item 160 compatible with the candidate visual element 170. The performance estimator 140 can apply the graphical characteristics of each arrangement of the constituent visual elements 165 and of the candidate visual element 170 to the performance prediction model. From the output of the performance prediction model, the performance estimator 140 can determine a component performance metric for the arrangement inputted into the performance prediction model. The component performance metric can include a semantic performance metric or an interaction semantic metric of the arrangement. Based on the component performance metrics over the entire set of arrangements, the performance estimator 140 can determine the combinative performance metrics of the constituent visual element 170 when inserted into the content item 160. In some implementations, the performance estimator 140 can apply factor analysis techniques to determine the combinative performance metric of the constituent visual element 170. The factor analysis techniques can include, for example, exploratory factor analysis, confirmatory factor analysis, regression analysis, and principal component analysis, among others.

Using the combinative performance metrics of the candidate visual elements 170, the element selector 145 can select one or more the candidate visual elements 170 to add or insert into the content item 160. The type of performance metric used to compare and select the candidate visual elements 170 can be the sentiment performance metric (e.g., persuasion, linkage, salience, memorability, or emotion response) or interaction performance metric (e.g., number of views, hover-over rate, or click-through rate). In selecting the candidate visual elements 170, the element selector 145 can compare between the same types of combinative performance metric or aggregate performance metric. In some implementations, the element selector 145 can rank the candidate visual elements 170 by the combinative performance metrics (or by the aggregate performance metric). From the ranking of the candidate visual elements 170, the element selector 145 can select a subset of the candidate visual elements 170 with the highest corresponding combinative performance metrics (or by the aggregate performance metric). For example, the element selector 145 can select three of the candidate visual elements 170 with the highest three combinative performance metrics. In some implementations, the element selector 145 can select the candidate location for the candidate visual element 170 based on the combinative performance metric (or the aggregate performant metric) corresponding to the candidate location. For each candidate visual element 170, the element selector 145 can rank the compatible candidate locations within the content item 160 by the combinative performance metric (or the aggregate performance metric) corresponding to each candidate location. From the ranking of the compatible candidate locations, the element selector 145 can select a subset of the candidate locations with highest corresponding combinative performance metrics (or aggregate performance metrics). In this manner, both the candidate visual elements 170 as well as the candidate locations within the content item 160 can be selected for insertion into the content item 160.

In some implementations, one or more of the candidate visual elements 170 can be automatically selected by the element selector 145. The element selector 145 can select one or more of the candidate visual elements 170 for insertion into the content item 160 based on the combinative performance metrics or the aggregate performance metrics as detailed above, without any administrator input. In some implementations, one or more of the candidate visual elements 170 can be manually selected for insertion into the content item 170 via a content selection management interface. The content selection management interface can be provided by the data processing system 110 to another computing device (e.g., the content provider 115, the content publisher, 120, or the client device 125). The element selector 145 can display or present the candidate visual elements 170 as recommendations to insert into the content item 160 based on the corresponding combinative performance metrics on the content selection management interface. In some implementations, the element selector 145 can present a subset of candidate visual elements 170 with combinative performance metrics (or aggregate performance metrics) greater than a threshold metric. In some implementations, the element selector 145 can present the subset of candidate visual elements 170 ranked by the combinative performance metrics or the aggregate performance metrics. In some implementations, the element selector 145 can present the subset of candidate visual elements 170 with the external characteristics associated with each visual element 170. As discussed above, the external characteristics can include a topical category of an information resource on which the content item is to be inserted and a designated audience segment, among others. The external characteristics can be presented or displayed as a text label with the subset of candidate visual elements 170. Using the content selection management interface, one or more of the candidate visual elements 170 can be selected for insertion into the content item 160. In some implementations, the content selection management interface can be used to select a candidate location within the content item 160 to insert one of the candidate visual elements 170. More details regarding the content selection management interface are described herein in conjunction with FIGS. 2A-3C.

With the selection of the candidate visual elements 170 based on the combinative performance metric or the aggregate performance metric, the element selector 145 can add or insert the selected candidate visual elements 170 into the content item 160. In some implementations, the element selector 145 can insert the selected candidate visual elements 170 at the position corresponding to the selected candidate location. In some implementations, the element selector 145 can insert the selected candidate visual elements 170 responsive to the selection via the content selection management interface. In some implementations, the element selector 145 can identify a corresponding script for each selected candidate visual element 170. The script can be in a markup language (e.g., HyperText Markup Language (HTML) and Cascading Style Sheets (CSS)), and specify how an application (e.g., a web browser) is to render the candidate visual element 170 within the content item 160. The element selector 145 can insert the corresponding script for the selected candidate visual element 170 into the script corresponding to the script for the content item 160. Once added, the content item 160 can include the constituent visual elements 165 and the one or more selected candidate visual elements 170. The selected candidate visual element 170 can be inserted by the element selector 145 as a child DOM element into the DOM element corresponding to the content item 160. In some implementations, the DOM element corresponding to the candidate visual element 170 can be inserted by the element selector 145 as a child to one of the DOM elements corresponding to one of the constituent visual elements 165 of the content item 160.

To measure the performance of the content item 160 with the candidate visual element 170 inserted, the presentation tracker 150 can display or present the content item 160 across one or more information resources (e.g., webpages) accessed by the client devices 125. In some implementations, the presentation tracker 150 (or another server) can send the content item 160 to the client device 125 in response to receiving a request to insert content into a content slot (e.g., inline frame) of the information resource. The information resource may have been requested by the client device 125 prior to or in conjunction with the sending of the request to insert content into the content slot. In some implementations, the presentation tracker 150 can provide the content item 160 with the inserted candidate visual element 170 to a separate server or another component of the data processing system 110 to distribute the content item 160 to a multitude of client devices 125.

From providing the content item 160 to the multitude of client devices 125, the presentation tracker 150 can identify or determine an interaction statistic for the content item 160 with the insertion of the candidate visual element 170. The content item 160 can include a script to send an indicator of interaction with the content item 160 from the client device 125 when executed and displayed on the information resource. The indicator can specify a type of interaction, such as a view, a hover-over, or a click-through, among others. In some implementations, the indicator can also include a location of the interaction within the content item 160. In some implementations, the indicator can include an audience segment identifier corresponding to the client device 125. The audience segment identifier can specify a trait (e.g., geographic location or device type) of the client device 125 presented with the content item 160. The presentation tracker 150 can aggregate the indicators received from multiple client devices 125 when presented with the content item 160 with the insertion of the candidate visual element 170. Using the aggregated indicators, the presentation tracker 150 can calculate or determine the interaction statistic for the content item 160. The interaction statistic can include a number of views, a rate of hovers, and a rate of click through, among others, by the client devices 125 provided with the content item 160. In some implementations, the presentation tracker 150 can also store the location of the interaction within the content item 160. In some implementations, the presentation tracker 150 can also store the audience segment identifier corresponding to the client device 125. With the determination, the presentation tracker 150 can present the interaction statistics of the content item 160 without the candidate visual element 170 via a content selection management interface. The content selection management interface can also indicate the locations of the interactions and the audience segment identifier for the client devices 125 interacting with the content item 160. More details regarding the content selection management interface are described herein in conjunction with FIGS. 2A-3C.

In some implementations, the presentation tracker 150 can perform statistical hypothesis testing (e.g., AB testing) to measure or determine the performance of the content item 160 with and without the candidate visual element 170. In providing the content item 160 to the client devices 125, the presentation tracker 150 can send the content item 160 with the inserted candidate visual element 170 to one set of client devices 125 for display on information resources. In addition, the presentation tracker 150 can send the content item 160 without the inserted candidate visual element 170 to another set of client devices 125 for display on information resources. With or without the candidate visual element 170, the content item 160 can include a script to send an indicator of interaction with the content item 160 from the client device 125 when executed and displayed on the information resource. The indicator can specify a type of interaction, such as a view, a hover-over, or a click-through, among others. The indicator an specify whether the candidate visual element 170 was inserted in the content item 160. In some implementations, the indicator can also include a location of the interaction within the content item 160. In some implementations, the indicator can include an audience segment identifier corresponding to the client device 125. The presentation tracker 150 can aggregate the indicators received from the multitude of client devices 125 when presented with the content item 160.

Based on the aggregated indicators, the presentation tracker 150 can calculate or determine an interaction statistic for the content item 160 with the candidate visual element 170. Additionally, the presentation tracker 150 can calculate or determine a separate interaction statistic for the content item 160 without the candidate visual element 170 based on the aggregated indicators. The interaction statistic can include a number of views, a rate of hovers, and a rate of click through, among others, by the client devices 125 provided with the content item 160. The presentation tracker 150 can identify the indicators specifying that the candidate visual element 170 is inserted into the content item 160. Using the identified indicators, the presentation tracker 150 can determine the interaction statistics for the content item 160 with the candidate visual element 170 based on the type of interaction. The interaction statistic can indicate the number of views, the hover-over rates, and the click-through rates of the content item 160 with the candidate visual element 170. The presentation tracker 150 can identify the indicators specifying that the candidate visual element 170 is not inserted into the content item 160. Using the identified indicators, the presentation tracker 150 can determine the interaction statistics for the content item 160 with the candidate visual element 170 based on the type of interaction. The interaction statistic can indicate the number of views, the hover-over rates, and the click-through rates of the content item 160 without the candidate visual element 170. With the determination, the presentation tracker 150 can present the interaction statistics of the content item 160 with and without the candidate visual element 170 via a content selection management interface. The content selection management interface can also indicate the locations of the interactions and the audience segment identifier for the client devices 125 interacting with the content item 160. More details regarding the content selection management interface are described herein in conjunction with FIGS. 2A-3C.

Using the interaction statistics determined from presenting the content item 160 to the multitude of client devices 125, the model trainer 130 can update the performance prediction model. In some implementations, the model trainer 130 can identify the one or more graphical characteristics of the content item 160, such as size, color, and font style, among others. The model trainer 130 can identify the one or more graphical characteristics of the content item 160 with and without the candidate visual element 165. In addition, the model trainer 130 can identify the one or more graphical characteristics of each of the constituent visual elements 165, such as position, size, color, font style, and time duration. The model trainer 130 can further identify the one or more graphical characteristics of each candidate visual element 170 inserted into the content item 160. The model trainer 130 can apply the identified graphical characteristics of the content item 160 into the input of the performance prediction model. With the application of the inputs, the performance prediction model can output an estimated total performance metric of the content item 160. From the output, the model trainer 130 can obtain or determine the estimated total performance metric. The estimated total performance metric can be an interaction performance metric, such as the number of views, the hover-over rate, and the click-through rate, among others. The model trainer 130 can calculate or determine a deviation measure between the total performance metric estimated by the performance prediction model and the interaction statistics measured from presenting the content item 160 to the client devices 125. Based on the deviation measure, the model trainer 130 can adjust the weights of the performance prediction model. In this manner, subsequent applications of the inputs to the performance prediction model may result in more accurate predictions of the interaction performance metrics of various content items.

Referring now to FIG. 2A, depicted is a block diagram depicting a graphical user interface (GUI) 200A for selecting visual elements based on sentiment analysis. The GUI 200A can correspond to the content selection management interface as previously discussed, and can include a content item 205 and a window for sentiment analysis results 215, among others. The content item 205 can correspond to the content item 160, and include an image element 210A, a text element 210B, and a link element 210C. The image element 210A, the text element 210B, and the link element 210C each can correspond to one of the constituent visual elements 165. In the context of FIG. 1, the content interface 135 can identify one or more graphical characteristics for each of the image element 210A, the text element 210B, and the link element 210C. Using the graphical characteristics applied to the performance prediction model, the performance estimator 140 can determine total sentiment performance metrics for the content item 205 overall. In addition, the performance estimator 140 can determine contributory sentiment performance metrics for each of the image element 210A, the text element 210B, and the link element 210C. The sentiment performance metrics determined by the performance estimator 140 can include persuasion 220A, linkage 220B, salience 220C, and memorability 220D. The performance estimator 140 can display the total and contributory sentiment performance metrics on bar graphs 225A-D. Bar graph 225A can correspond to persuasion 220A. Bar graph 225B can correspond to linkage 225B. Bar graph 225C can correspond to salience 220C. Bar graph 225D can correspond to memorability 220D. Each bar graph 225A-D can show the total sentiment performance metric, and three segments 230A-C. Each segment 230A-C can show the contributory sentiment performance metric of each of the image element 210A, the text element 210B, and the link element 210C to the total sentiment performance metric of the overall content item 205. Segment 230A can correspond to the contributory sentiment performance metric of the image element 210A. Segment 230B can correspond to the contributory sentiment performance metric of the text element 210B. Segment 230C can correspond to the contributory performance metric of the link element 210.

Referring now to FIG. 2B, depicted is a block diagram depicting a graphical user interface (GUI) 200B for selecting visual elements based on sentiment analysis. The GUI 200B can correspond to the content selection management interface as previously discussed. The GUI 200B can include the content item 205 with the image element 210A, the text element 210B, and the link element 210C. Furthermore, the GUI 200B can include a window of a list of elements to add 235. The list of elements to add 235 can include a set of recommended visual elements 240A-C to insert into the content item 205. In the context of FIG. 1, the list of elements to add 235 can be determined and selected by the performance estimator 140 and the element selector 145. The recommended visual elements 240A-C can be selected from the candidate visual elements 170 to insert into the content item 160. For candidate visual element 170, the performance estimator 140 may have determined the combinative performance metric when the candidate visual element 170 is added to the content item 160. Based on the calculated combinative performance metrics, the element selector 145 may have selected the top three candidate visual elements 170 with the three highest combinative performance metrics as the recommended visual elements 240A-C.

Referring now to FIG. 2C, depicted is a block diagram depicting a graphical user interface (GUI) 200C for selecting visual elements based on sentiment analysis. The GUI 200C can correspond to the content selection management interface as previously discussed. The GUI 200C can include the content item 205 with the image element 210A, the text element 210B, and the link element 210C as from the GUIs 200A and 200B. In GUI 200C, the content item 205 can further include a text element 210D. The text element 210 may have been selected from the list of elements to add 235 from GUI 200B. In addition, the GUI 200C can include a window showing performance results 245. In the context of FIG. 1, the performance results 245 may have been generated and determined by the presentation tracker 150. The presentation tracker 150 may have performed AB testing over two sets of clients devices 125. The presentation tracker 150 may have distributed or provided the content item 205 with the image element 210A, the text element 210B, the link element 210C, and the text element 210D to one set of client devices 125. The presentation tracker 150 may have distributed or provided the content item 205 with the image element 210A, the text element 210B, and the link element 210C, but without the text element 210D to another set of client devices 125. From the provision of the content item 205, the presentation tracker 150 can determine the interaction statistics.

The interaction statistics can include a number of views 250A, a hover-over rate 250B, and a click-through rate 250, and can be displayed using the performance results 245 window. The interaction statistics can be further divided into two bar graphs for the two sets of clients devices 125. Bar graph 255A can correspond to the number of views of the content item 205 with the text element 210D by the corresponding set of client devices 125. Bar graph 255B can correspond to the number of views of the content item 205 without the text element 210D by the corresponding set of client devices 125. Bar graph 255′A can correspond to the hover-over rates on the content item 205 with the text element 210D by the corresponding set of client devices 125. Bar graph 255′B can correspond to the hover-over rate of the content item 205 without the text element 210D by the corresponding set of client devices 125. Bar graph 255″A can correspond to the click-through rates on the content item 205 with the text element 210D by the corresponding set of client devices 125. Bar graph 255″B can correspond to the click-through rates of the content item 205 without the text element 210D by the corresponding set of client devices 125.

Referring now to FIG. 3A, shown is a screenshot of a graphical user interface (GUI) 300A for selecting visual elements based on sentiment analysis. The GUI 300A can correspond to the content selection management interface as previously discussed. The GUI 300A can include a first section 305 showing rendering of two content items. For each content item rendered in the first section 305, the GUI 300A can include a second section 310 showing a target interaction statistic for the content items. In addition, the GUI 300A can include a third section 315 showing a predicted emotional response to the content item. The predicted emotional response may have been determined by the performance estimator 140. Furthermore, the GUI 300A can include a fourth section 320 showing other predicted sentiment performance metrics, such as “persuasion,” “linkage,” “cut-through” (sometimes referred herein as salience), and “key message” (sometimes referred herein as memorability).

Referring now to FIG. 3B, shown is a screenshot of a graphical user interface (GUI) 300B for selecting visual elements based on sentiment analysis. The GUI 300B can correspond to the content selection management interface as previously discussed. The GUI 300B can include multiple recommendations 325A, 325B, 330A, and 330B to modify a content item (e.g., the content item 160 or 205). In the context of FIG. 1, the recommendations 325A, 325B, 330A, and 330B may have been determined and selected by the performance estimator 140 and the element selector 145. For example, the performance estimator 140 may have determined that additional text elements correspond to a higher aggregate performance metric in providing recommendation 325A. The performance estimator 140 may have determined that having different types of elements corresponds to a higher aggregate performance metric in providing recommendation 325B. The performance estimator 140 may have determined that adding another element with different colors as the existing content item results in a higher aggregate performance metric in providing recommendation 330A. Additionally, the performance estimator 140 may have determined that one or more image elements can have a positive combinative performance metric when inserted into the content item.

Referring now to FIG. 3C, shown is a screenshot of a graphical user interface (GUI) 300C for selecting visual elements based on sentiment analysis. The GUI 300C can correspond to the content selection management interface as previously discussed. The GUI 300C can include a detailed breakdown of performance metrics and interaction statistics of a content item. The GUI 300C can include a first section 335 displaying interaction statistics over time relative a target statistic for a content item (e.g., the content item 160 or 205). The GUI 300C can include a second section 340 showing distribution of device types corresponding to client devices 125 presented with the content item. The GUI 300C can include a third section 345 showing a heat map of interactions on various locations within the content item. The GUI 300C can include a fourth section 350 showing a predicted emotional response to the content item using the performance prediction model. The GUI 300C can include a fifth section 355 showing a distribution of audience segments of the client devices 125 presented with the content item. The GUI 300C can include a sixth section 360 showing a geographic distribution of the client devices 125 presented with the content item. The GUI 300C can include a seventh section 370 showing other sentiment performance metrics, such as “persuasion,” “linkage,” “cut-through” (sometimes referred herein as salience), and “key message” (sometimes referred herein as memorability). The GUI 300C can include an eighth section 380 showing other audience segments with respect to the presentation of the content item on the client devices 125.

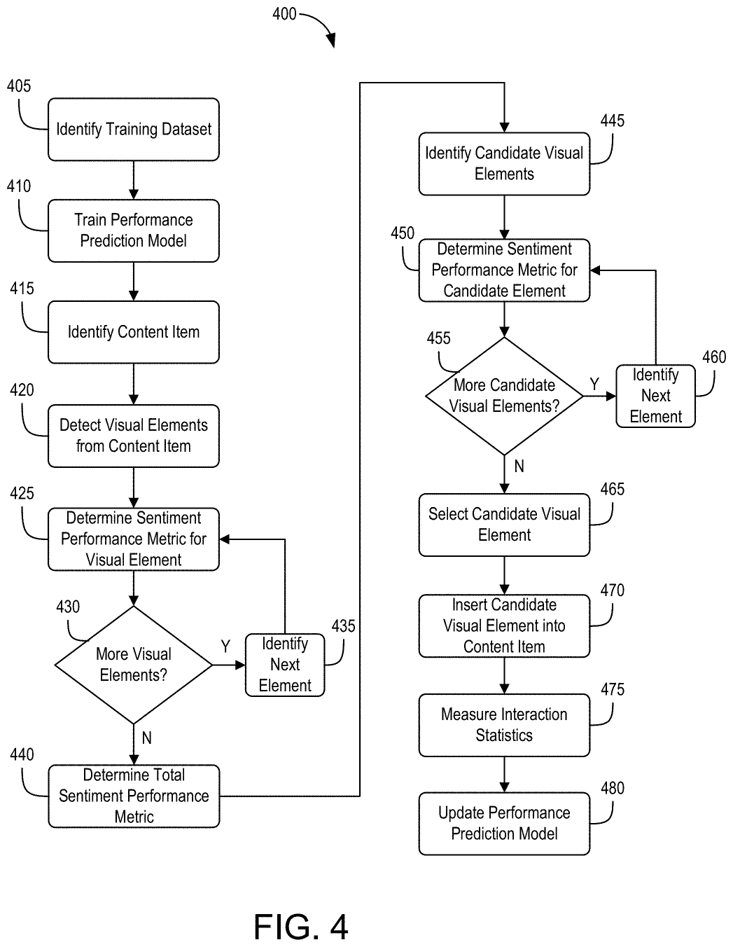

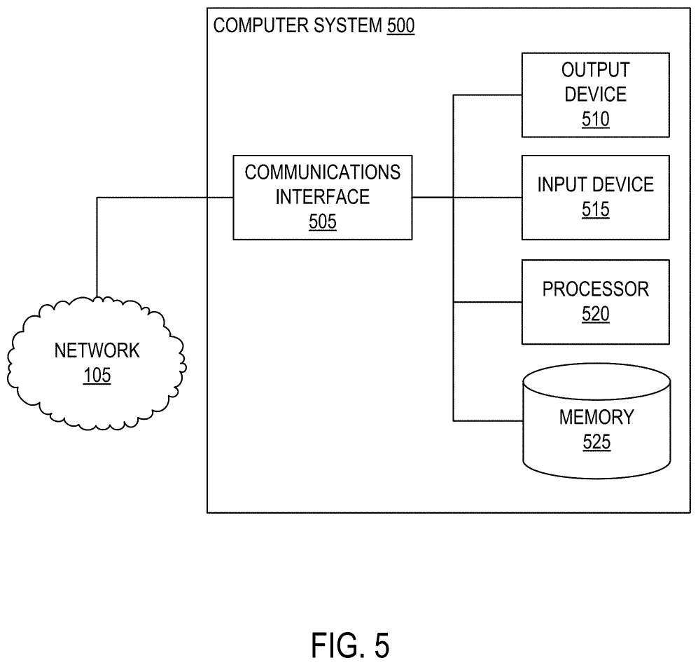

Referring to FIG. 4, FIG. 4 is a flow diagram depicting a method 400 of selecting visual elements based on sentiment analysis. The functionality described herein with respect to method 500 can be performed or otherwise executed by the data processing system 110 or client device 125, as shown in FIG. 1 or a computing system as shown in FIG. 5, or any combination thereof. A data processing system can identify a training dataset (405). The data processing system can train a performance prediction model (410). The data processing system can identify a content item (415). The data processing system can detect visual elements from the content item (420). The data processing system can determine a sentiment performance metric for the visual element (425). The data processing system can determine whether there are more visual elements in the content (430). If so, the data processing system can identify a next visual element (435). Otherwise, the data processing system can determine a total sentiment performance metric (440). The data processing system can identify candidate visual elements (445). The data processing system can determine a sentiment performance metric for a candidate visual element (450). The data processing system can determine whether there are more candidate visual elements (455). If so, the data processing system can identify a next candidate visual element (460). Otherwise, the data processing system can select candidate visual elements (465). The data processing system can insert the candidate visual element into the content item (470). The data processing system can measure an interaction statistics (475). The data processing system can update the performance prediction model (480).

In further detail, the data processing system (e.g., the data processing system 110) can identify a training dataset (405). The training dataset can include a set of test content items associated with measured sentiment performance metrics or measured interaction performance metrics, among others. The training dataset can specify graphical characteristic of each content item and of the constituent visual elements in the content item, such as size, color, and font style, among others. The data processing system can train a performance prediction model (410). Using the training dataset, the data processing system can train the performance prediction model (e.g., until convergence). The performance prediction model can be, for example, an artificial neural network (ANN). The performance prediction model can include a set of inputs, a set of outputs, and a set of weights. The set of inputs can include the graphical characteristics of the constituent visual elements of the content item. The set of outputs can include the performance metrics. The set of weights can correlate the graphical characteristics of the content item to numeric values for the performance metrics.

The data processing system can identify a content item (e.g., the content item 160) (415). The content item can be accessed from a database or from a content provider, and may be provided to the data processing system as part of a request. The data processing system can detect visual elements (e.g., constituent visual elements 165) from the content item (420). The content item can already include one or more visual elements, such as such as an image element, a text element, a link element, a video element, and a canvas element, among others. The data processing system can apply an object recognition algorithm on a rendering of the content item to identify the visual elements. The data processing system can also parse a script for the content item to identify visual elements. With the detection of the visual elements, the data processing system can identify graphical characteristics of each visual element and of the content item overall.

The data processing system can determine a sentiment performance metric for the visual element (425). The data processing system can apply the graphical characteristics of the constituent visual elements of the content item as inputs to the performance prediction model. From the output of the performance prediction model, the data processing system can obtain the sentiment performance metric for the visual element. The data processing system can determine whether there are more visual elements in the content (430). If so, the data processing system can identify a next visual element (435). Otherwise, the data processing system can determine a total sentiment performance metric (440). The data processing system can determine the total sentiment performance metric of the overall content item based on a combination of the individual sentiment performance metrics of the constituent visual elements of the content item.

The data processing system can identify candidate visual elements (445). The data processing system can determine a sentiment performance metric for a candidate visual element (450). The data processing system can identify graphical characteristics of the candidate visual element. The data processing system can then apply the graphical characteristics as inputs to the performance prediction model. From the output of the performance prediction model, the data processing system can obtain the sentiment performance metric for the candidate visual element when added to the content item. The data processing system can determine whether there are more candidate visual elements (455). If so, the data processing system can identify a next candidate visual element (460). Otherwise, the data processing system can select candidate visual elements (465). The data processing system can rank the candidate visual elements by the individual sentiment performance metrics. From the ranking, the data processing system can select a subset of the candidate visual elements with the highest sentiment performance metrics estimated using the performance prediction model. The data processing system can insert the candidate visual element into the content item (470).

The data processing system can measure an interaction statistics (475). In measuring the interaction statistics, the data processing system can provide the content item with the inserted candidate visual element to a set of client devices. When the client device detects an interaction with the content item, the data processing system can receive an indication of the interaction from the client device. The data processing system can aggregate the indications from a multitude of client devices to determine the interaction statistics of the content item. The interaction statistics can include a number of views, a hover-over rate, and a click-through rate, among others. The data processing system can update the performance prediction model (480). The data processing system can update the performance prediction model based on the interaction statistics aggregated for the content item with the candidate visual element added thereto.

FIG. 5 shows the general architecture of an illustrative computer system 500 that may be employed to implement any of the computer systems discussed herein (including the data processing system 110 and its components such as the model trainer 130, the content interface 135, the performance estimator 140, the element selector 145, the presentation tracker 150, and the database 155) in accordance with some implementations. The computer system 500 can be used to provide information via the network 105 for display. The computer system 500 of FIG. 5 comprises one or more processors 520 communicatively coupled to memory 525, one or more communications interfaces 505, and one or more output devices 510 (e.g., one or more display units) and one or more input devices 515. The processors 520 can be included in the data processing system 110 or the other components of the data processing system 110 such as the model trainer 130, the content interface 135, the performance estimator 140, the element selector 145, and the presentation tracker 150.

In the computer system 500 of FIG. 5, the memory 525 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the data processing system 110 of FIG. 1, the data processing system 110 can include the memory 525 to store information related to the availability of inventory of one or more content units, reservations of one or more content units, among others. The memory 525 can include the database 155. The processor(s) 520 shown in FIG. 5 may be used to execute instructions stored in the memory 525 and, in so doing, also may read from or write to the memory various information processed and or generated pursuant to execution of the instructions.

The processor 520 of the computer system 500 shown in FIG. 5 also may be communicatively coupled to or control the communications interface(s) 505 to transmit or receive various information pursuant to execution of instructions. For example, the communications interface(s) 505 may be coupled to a wired or wireless network, bus, or other communication means and may therefore allow the computer system 500 to transmit information to or receive information from other devices (e.g., other computer systems). While not shown explicitly in the system of FIG. 1, one or more communications interfaces facilitate information flow between the components of the system 500. In some implementations, the communications interface(s) may be configured (e.g., via various hardware components or software components) to provide a website as an access portal to at least some aspects of the computer system 500. Examples of communications interfaces 505 include user interfaces (e.g., web pages), through which the user can communicate with the data processing system 110.

The output devices 510 of the computer system 500 shown in FIG. 5 may be provided, for example, to allow various information to be viewed or otherwise perceived in connection with execution of the instructions. The input device(s) 515 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device. The operations described in this specification can be implemented as operations performed by a data processing apparatus on data stored on one or more computer-readable storage devices or received from other sources.

The terms “data processing apparatus”, “data processing system”, “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The model trainer 130, the content interface 135, the performance estimator 140, the element selector 145, and the presentation tracker 150 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 500 or system 110 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the model trainer 130, the content interface 135, the performance estimator 140, the element selector 145, and the presentation tracker 150 can be part of the data processing system 110, a single module, a logic device having one or more processing modules, or one or more servers.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to selecting visual elements to insert into content items based on sentiment analysis, the systems and methods described herein can include applied to other environments. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method of selecting visual elements to insert into content items based on sentiment analysis, comprising:
establishing, by a data processing system having one or more processors, a performance prediction model for content items correlating constituent visual elements to sentiment performance metrics using a training dataset having a plurality of test content items, each test content item having a plurality of visual elements and a measured sentiment performance metric;
identifying, by the data processing system, a content item and a plurality of candidate visual elements to insert into the content item, the content item having a plurality of constituent visual elements;
determining, by the data processing system, a total sentiment performance metric for the content item using the performance prediction model and the plurality of constituent visual elements of the content item;
determining, by the data processing system, for each candidate visual element of the plurality of candidate visual elements, a combinative performance metric between the candidate visual element and the plurality of visual elements of the content item using the performance prediction model, the combinative performance metric indicating a predicted effect on the total performance metric of the content item; and
selecting, by the data processing system, from the plurality of candidate visual element, a candidate visual element to insert into the content item based on the combinative performance metric for the candidate visual element with the plurality of constituent visual elements in the content item.

2. The method of claim 1, further comprising:
presenting, by the data processing system, across a plurality of information resources, the content item with the candidate visual element to a first set of client devices and the content item without the candidate visual element on the second set of client devices; and
determining, by the data processing system, from presenting across the plurality of information resources, a first interaction statistic for the content item with the candidate visual element and a second interaction statistic for the content item without the candidate visual element.

3. The method of claim 1, further comprising:
presenting, by the data processing system, on each information resource of a plurality of information resources, the content item with the candidate visual element on the information resource;
determining, by the data processing system, from presenting the content item on the plurality of information resources, an interaction statistic for the content item with the candidate visual element inserted; and
updating, by the data processing system, the performance prediction model based on the performance metric, the plurality of constituent visual elements of the content item, and the candidate visual element inserted into the content item.

4. The method of claim 1, further comprising:
determining, by the data processing system, for each constituent visual element of the plurality of constituent visual elements on the content item, a contributive performance metric of the constituent visual element using the performance prediction model; and
wherein determining the total sentiment performance metric further comprises determining the total sentiment performance metric based on the plurality of contributive performance metrics for the plurality of constituent visual elements on the content item.

5. The method of claim 1, further comprising:
identifying, by the data processing system, a plurality of audience segments to perceive the content item, each audience segment defined by a common trait;
wherein establishing the performance prediction model further comprises establishing the performance prediction model using the training dataset having the plurality of test content items, each test content item having the measured sentiment performance metric for each audience segment;
wherein determining the total sentiment performance metric further comprises determining the total sentiment performance metric of the content item for each audience segment of the plurality of audience segments; and
wherein determining the combinative performance metric further comprises determining the combinative performance metric of the candidate visual element for each audience segment of the plurality of audience segments.

6. The method of claim 1, wherein establishing the performance prediction model further comprises establishing the performance prediction model using the training dataset, the training dataset including a first test content item and a second test content item, the first content item having a visual element at a first location with a first measured sentiment performance metric, the second content item having the visual element at a second location with a second measured sentiment performance metric; and
wherein determining the combinative performance metric further comprises determining the combinative performance metric for the candidate visual element at a candidate location for insertion within the content item using the performance prediction model.

7. The method of claim 1, wherein establishing the performance prediction model further comprises establishing the performance prediction model using the training dataset, each test content item of the training dataset having the plurality of visual elements, each visual element having one or more graphical characteristics; and
wherein determining the combinative performance metric further comprise the determining the combinative performance metric based on one or more graphical characteristics of the candidate visual element using the performance prediction model.

8. The method of claim 1, wherein identifying the plurality of constituent visual elements further comprises identifying the plurality of constituent visual elements by at least one of: applying an object recognition algorithm on rendering of the content item to identify each visual element and parsing a script corresponding to the content item to identify each visual element.

9. The method of claim 1, further comprising receiving, by the data processing system, the measured sentiment performance metric for the test content item having the plurality of visual elements via a survey interface, the measured sentiment performance metric including at least one of persuasion, linkage, salience, and memorability.

10. The method of claim 1, further comprising presenting, by the data processing system, the plurality of candidate visual elements on a content selection management interface based on the plurality of combinative performance metrics for the corresponding plurality of candidate visual elements.

11. A system for selecting visual elements to insert into content items based on sentiment analysis, comprising:
a model trainer executable on a data processing system having one or more processors, configured to establish a performance prediction model for content items correlating constituent visual elements to sentiment performance metrics using a training dataset having a plurality of test content items, each test content item having a plurality of visual elements and a measured sentiment performance metric;
a content interface executable on the data processing system, configured to identify a content item and a plurality of candidate visual elements to insert into the content item, the content item having a plurality of constituent visual elements;
a performance estimator executable on the data processing system, configured to:
determine a total sentiment performance metric for the content item using the performance prediction model and the plurality of constituent visual elements of the content item; and
determine, for each candidate visual element of the plurality of candidate visual elements, a combinative performance metric between the candidate visual element and the plurality of visual elements of the content item using the performance prediction model, the combinative performance metric indicating a predicted effect on the total performance metric of the content item; and
an element selector executable on the data processing system, configured to select, from the plurality of candidate visual element, a candidate visual element to insert into the content item based on the combinative performance metric for the candidate visual element with the plurality of constituent visual elements in the content item.

12. The system of claim 11, further comprising a presentation tracker executable on the data processing system configured to:
present, across a plurality of information resources, the content item with the candidate visual element to a first set of client devices and the content item without the candidate visual element on the second set of client devices; and
determine, from presenting across the plurality of information resources, a first interaction statistic for the content item with the candidate visual element and a second interaction statistic for the content item without the candidate visual element.

13. The system of claim 11, further comprising a presentation tracker executable on the data processing system configured to:
present, on each information resource of a plurality of information resources, the content item with the candidate visual element on the information resource;
determine, from presenting the content item on the plurality of information resources, an interaction statistic for the content item with the candidate visual element inserted; and
wherein the model trainer is further configured to update the performance prediction model based on the performance metric, the plurality of constituent visual elements of the content item, and the candidate visual element inserted into the content item.

14. The system of claim 11, wherein the performance estimator is further configured to:
determine, for each constituent visual element of the plurality of constituent visual elements on the content item, a contributive performance metric of the constituent visual element using the performance prediction model; and
determine the total sentiment performance metric based on the plurality of contributive performance metrics for the plurality of constituent visual elements on the content item.

15. The system of claim 11, wherein the model trainer is further configured to:
identify a plurality of audience segments to perceive the content item, each audience segment defined by a common trait; and
establish the performance prediction model using the training dataset having the plurality of test content items, each test content item having the measured sentiment performance metric for each audience segment; and
wherein the performance estimator is further configured to:
determine the total sentiment performance metric of the content item for each audience segment of the plurality of audience segments; and
determine the combinative performance metric of the candidate visual element for each audience segment of the plurality of audience segments.

16. The system of claim 11, wherein the model trainer is further configured to establish the performance prediction model using the training dataset, the training dataset including a first test content item and a second test content item, the first content item having a visual element at a first location with a first measured sentiment performance metric, the second content item having the visual element at a second location with a second measured sentiment performance metric; and
wherein the performance estimator is further configured to determine the combinative performance metric for the candidate visual element at a candidate location for insertion within the content item using the performance prediction model.

17. The system of claim 11, wherein the model trainer is further configured to establish the performance prediction model using the training dataset, each test content item of the training dataset having the plurality of visual elements, each visual element having one or more graphical characteristics; and
wherein the performance estimator is further configured to determine the combinative performance metric based on one or more graphical characteristics of the candidate visual element using the performance prediction model.

18. The system of claim 11, wherein the content interface is further configured to identify the plurality of constituent visual elements by at least one of: applying an object recognition algorithm on rendering of the content item to identify each visual element and parsing a script corresponding to the content item to identify each visual element.

19. The system of claim 11, wherein the model trainer is further configured to receive the measured sentiment performance metric for the test content item having the plurality of visual elements via a survey interface, the measured sentiment performance metric including at least one of persuasion, linkage, salience, and memorability.

20. The system of claim 11, wherein the element selector is further configured to present the plurality of candidate visual elements on a content selection management interface based on the plurality of combinative performance metrics for the corresponding plurality of candidate visual elements.
